(19) United States
(12) Patent Application Publication
(10) Pub. No.: US 2025/0326155 A1
(43) Pub. Date: Oct. 23, 2025

(54) DOOR HARDWARE SUPPORTS AND METHODS OF MANUFACTURING THE SAME

(71) Applicant: Steves and Sons, Inc., San Antonio, TX (US)

(72) Inventors: Scott LOVETT, La Vernia, TX (US); Rene Ortiz, San Antonio, TX (US); Agustine Contreras, San Antonio, TX (US)

(73) Assignee: Steves and Sons, Inc., San Antonio, TX (US)

(21) Appl. No.: 19/183,489

(22) Filed: Apr. 18, 2025

Related U.S. Application Data
(60) Provisional application No. 63/636,151, filed on Apr. 19, 2024.

(51) Int. Cl. B27N 3/00; B27N 3/02; B27N 3/28; E06B 3/70

(52) U.S. Cl. CPC B27N 3/007; B27N 3/02; B27N 3/28; E06B 3/70; E06B 2003/7046

(57) ABSTRACT

This disclosure is directed to composite door hardware supports and methods of manufacturing the same. The composite door hardware supports can be formed using a wood particulate. The wood particulate can include a waste product of manufacturing one or more doors. In some cases, the composite door hardware supports can be formed by combining wood particulate with a polymer to form a moldable wood composite and passing the moldable wood composite through a die to form a wood composite extrusion. In some cases, the composite door hardware supports can be formed by scoring the wood composite extrusion at one or more breakage lines. The wood composite extrusion can then be broken at the one or more breakage lines to form the composite door hardware supports.

### CROSS-REFERENCE TO RELATED APPLICATIONS

This application claims the benefit of U.S. Provisional Patent Application No. 63/636,151, filed Apr. 19, 2024, the contents of which are incorporated herein by reference in their entirety.

### FIELD

This disclosure relates door hardware supports for hollow core or semi-solid core doors.

### BACKGROUND

Door hardware supports, which are sometimes referred to as “lock blocks,” can be installed within a hollow core or semi-solid core door to provide structural support for door hardware, for example, door handles, latch assemblies, and lock assemblies, installed on a hollow core or semi-solid core door. For example, a hollow core or semi-solid core door can include a peripheral frame and a pair of doorskins coupled to each side of the frame, and a door hardware support can be positioned within the cavity formed by the frame and the doorskins. The door hardware support is substantially rigid and thereby increases the stability and strength of the door and installed hardware.

Often, door hardware supports are manufactured using solid or laminated wood. This can require additional materials to be purchased to manufacture the door hardware supports. Additionally, manufacturing door hardware supports from solid or laminated wood results in material waste, for example, sawdust or scrap wood.

### BRIEF SUMMARY

In some embodiments, a method of manufacturing a plurality of door hardware supports for one or more hollow core or semi-solid core doors can include collecting wood particulate created as a waste product during a door manufacturing process; forming a moldable wood composite using the collected wood particulate; passing the moldable wood composite through a die including a rectangular cross-section to form a wood composite extrusion; and scoring the wood composite extrusion at one or more breakage lines, thereby defining the plurality of door hardware supports.

In some embodiments, a composite board can include wood particulate including a waste product of manufacturing one or more doors; a thermoplastic polymer; a length, a width less than the length, and a height less than or equal to the width; and a plurality of scoring recesses spaced apart along the length, each scoring recess extending across the width and defining an area of decreased height relative to an adjacent height of the composite board. In some embodiments, the composite board can be configured to be manually breakable at the scoring recesses to form a plurality of door hardware supports.

In some embodiments, a door hardware support for a door can include wood particulate including a waste product of manufacturing one or more doors; a thermoplastic polymer; and a length, a width less than the length, and a height less than or equal to the width. In some embodiments, the length can be between 5 inches and 15 inches, the width can be between 2 inches and 6 inches, and the height can be between 1 inch and 3 inches.

In some embodiments, a door can include a frame; a first doorskin coupled to the frame; a second doorskin coupled to the frame; and a door hardware support positioned between the first and second doorskins and coupled to one or more of the frame, the first doorskin, and the second doorskin. In some embodiments, the door hardware support can include wood particulate including a waste product of manufacturing one or more doors; a thermoplastic polymer; and a length, a width less than the length, and a height less than or equal to the width. In some embodiments, the length can be between 5 inches and 15 inches, the width can be between 2 inches and 6 inches, and the height can be between 1 inch and 3 inches.

### BRIEF DESCRIPTION OF THE DRAWINGS

The accompanying figures, which are incorporated herein, form part of the specification and illustrate embodiments of this disclosure. Together with the description, the figures further serve to explain the principles of and to enable a person skilled in the relevant arts to make and use the invention.

FIG. 1A depicts an exemplary hollow core or semi-solid core door according to some embodiments.

FIG. 1B depicts a portion of the exemplary hollow core or semi-solid core door of FIG. 1A.

FIG. 2A depicts a top view of an exemplary composite board according to some embodiments.

FIG. 2B depicts a side view of the exemplary composite board of FIG. 2A according to some embodiments.

FIG. 3 depicts an exemplary door hardware support according to some embodiments.

FIG. 4 depicts method of manufacturing one or more door hardware supports according to some embodiments.

### DETAILED DESCRIPTION

Embodiments of the present invention will now be described in detail with reference to embodiments thereof as illustrated in the accompanying drawings. References to “one embodiment,” “an embodiment,” “an example embodiment,” “some embodiments,” “exemplary,” etc., indicate that the embodiment described can include a particular feature, structure, or characteristic, but every embodiment may not necessarily include the particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

Unless clearly indicated to the contrary (e.g., “either x or y, but not both x and y”) or readily contextually apparent, the term “or” as used herein is inclusive (i.e., “x or y” includes just x, just y, and x and y, and “x, y, or z” includes just x, just y, just z, and any combination thereof). Moreover, such phrases are not necessarily referring to the same embodiment.

The term “about” or “substantially” or “approximately” as used herein means the value of a given quantity that can vary based on a particular technology. Based on the particular technology, the term “about” or “substantially” or “approximately” can indicate a value of a given quantity that varies within, for example, 0.1-10% of the value (e.g., ±0.1%, ±1%, ±2%, ±5%, or ±10% of the value).

Numerical values, including endpoints of ranges, can be expressed herein as approximations preceded by the term “about,” “substantially,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint. Additionally, it will be further understood that a range expressed as “between” “X” and “Y” includes any value interposed by X and Y as well as X and Y.

The term “invention” or “present invention” as used herein is a non-limiting term and is not intended to refer to any single embodiment of the particular invention but encompasses all possible embodiments as described in the application.

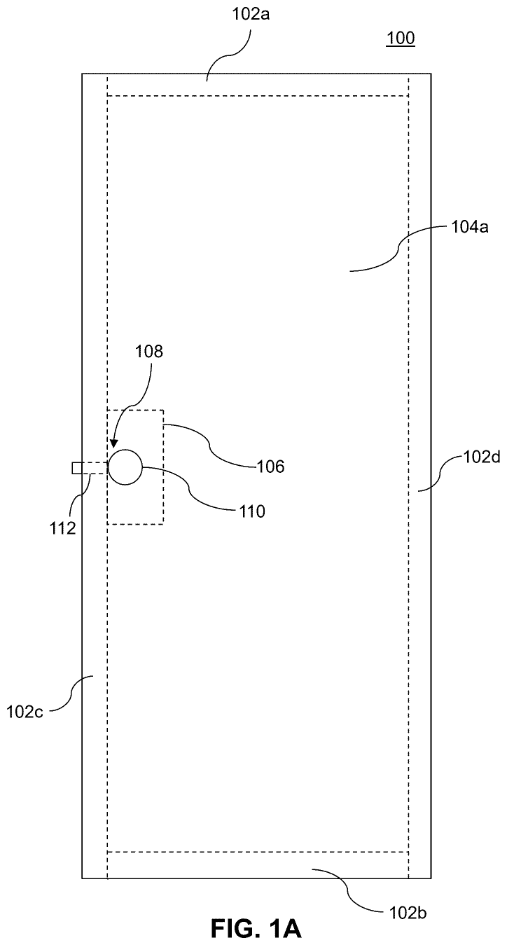

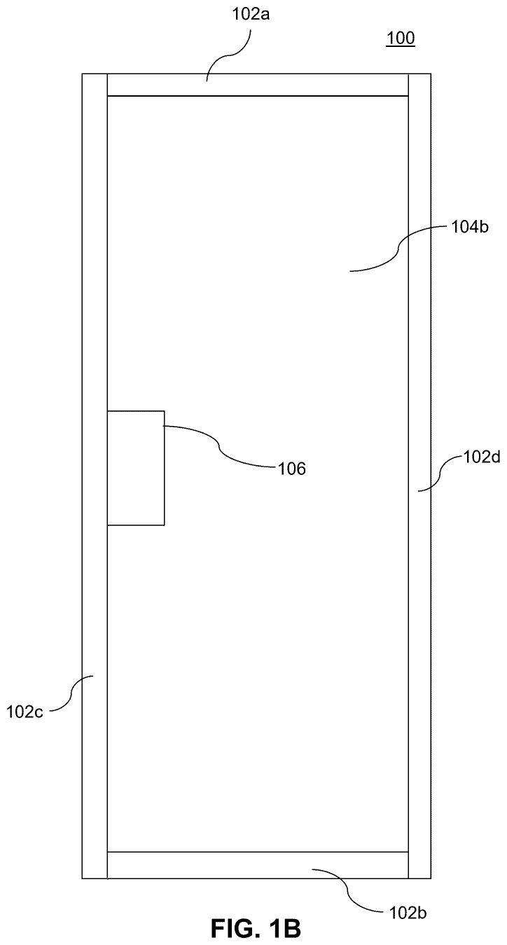

FIGS. 1A-1B show a door 100 according to some embodiments. Door 100 can be, for example, an exterior or interior door. In some embodiments, door 100 is a hollow core door. In some embodiments, door 100 is a semi-solid core door. Door 100 can include a frame 102. Frame 102 can define the outer periphery of door 100. Frame 102 can include a first frame portion 102a, a second frame portion 102b, a third frame portion 102c, and a fourth frame portion 102d. First and second frame portions 102a-b can be rails and second and third frame portions 102c-d can be stiles. Door 100 can also include a first doorskin 104a (shown in FIG. 1A) and a second doorskin 104b (shown in FIG. 1B) coupled to opposing sides of frame 102. Frame 102 and doorskins 104a and 104b collectively define an interior cavity.

Door 100 can include a door hardware support 106. Door hardware support 106 can be positioned in the interior cavity between first doorskin 104a and second doorskin 104b. The dotted lines in FIG. 1A illustrate frame 102 and door hardware support 106 behind first doorskin 104a. FIG. 1B shows door 100 with first doorskin 104a removed or not yet attached to frame 102, thus revealing frame 102 and door hardware support 106. In some embodiments, door hardware support 106 can be coupled to one or more of frame 102 (e.g., to third frame portion 102c), first doorskin 104a, and second doorskin 104b using an adhesive, screws, nails, brackets, etc.

In some embodiments, door hardware support 106 is positioned at a location of a typical door handle height. For example, in some embodiments, at least a portion of a door hardware support 106 is positioned at a height of between 34 inches and 38 inches from the bottom of door 100. In some embodiments, at least a portion of a door hardware support 106 is positioned below the vertical center of door 100.

In some embodiments, door hardware support 106 is positioned at a location of a typical dead bolt lock assembly. For example, in some embodiments, at least a portion of a door hardware support 106 is positioned at a height of between 40 inches and 50 inches from the bottom of door 100.

As shown in FIG. 1A, in use, door hardware support 106 can support various door hardware components, including for example handle assembly 108. Handle assembly 108 can include a doorknob or door lever 110 and a latch assembly 112 configured to catch in a cavity of a door jamb, for example, a cavity surrounded by a strike plate. Doorknob or door lever 110 can be operated to extend or retract latch assembly 112.

Door hardware support 106 can increase the structural integrity of the area of door 100 supporting handle assembly 108. Accordingly, handle assembly 108 can be more difficult to compromise. Door hardware support 106 can increase the rigidity of door 100 at the location of any door hardware operated by a user (e.g., handle assembly 108 or a dead bolt lock assembly). Accordingly, door hardware support 106 can prevent flexing of components of door 100 (e.g., doorskins 104a or 104b) when a user operates the hardware. Additionally, door hardware support 106 can enable fasteners (e.g., screws) used to attach the hardware to be sufficiently tightened without flexing doorskins 104a or 104b, as force applied to the fasteners during the tightening process is counteracted by door hardware support 106. Once attached, the fasteners can remain securely fixed to door hardware support 106 due to its density and rigidity.

While door 100 is shown in FIGS. 1A-1B as having only door hardware support 106 between portions of frame 102 and first and second doorskins 104a-b, in some embodiments, door 100 can include additional intervening structure, such as cardboard, foam, plastic, or wood spacers and frame structures. Accordingly, door 100 can be either a hollow core door or a semi-solid core door.

In some embodiments, door hardware support 106 can be positioned at either side of door 100, not just a left side as shown in FIGS. 1A-1B, such that door 100 can be configured as either a right-handed or left-handed door. In some embodiments, door 100 can include two door hardware supports 106, one on either side of door 100, such that door 100 can be both a right-handed or left-handed door depending on how it is hung.

Door hardware support 106 can be a composite door hardware support. That is, door hardware support 106 can be formed using a combination of wood particulate (e.g., sawdust) and a polymer, as described herein.

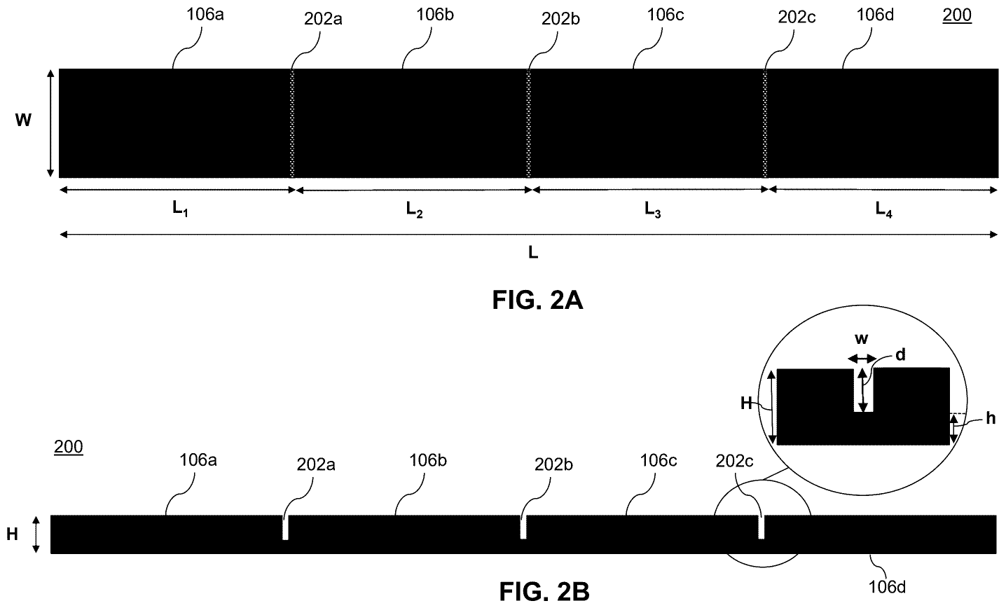

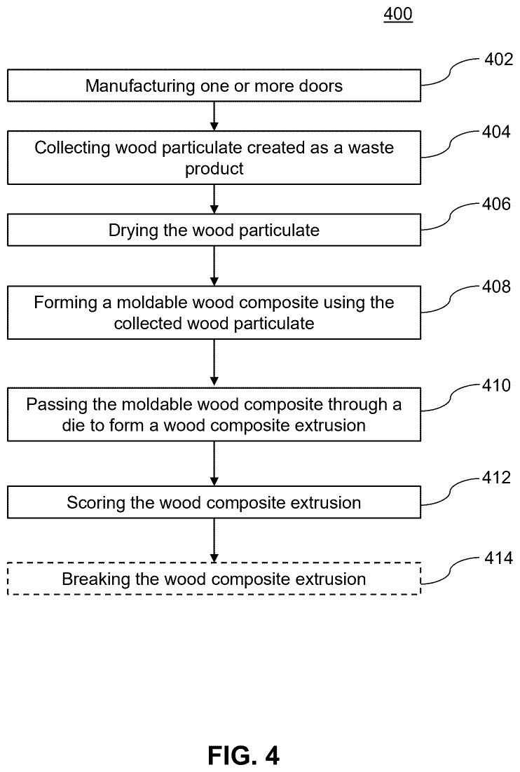

FIGS. 2A-2B illustrate a composite board 200 according to some embodiments. In some embodiments, composite board 200 can be an intermediate product in the production of a plurality of door hardware supports 106. In some embodiments, composite board 200 can be an extrusion, as described with respect to FIG. 4. However, composite board 200 is not limited to an extrusion. For example, in some embodiments, composite board 200 can be injection molded.

Composite board 200 can include a wood particulate. In some embodiments, the wood particulate can be a waste product of manufacturing one or more doors. For example, the wood particulate can include wood dust, wood chips, or wood shavings produced by sawing/cutting, sanding, milling, drilling, or routing various door components (e.g., stiles, rails, doorskins, panels, mullions, knob cavities, etc.) of one or more hollow core, semi-solid core, or solid core doors. In some embodiments, the wood particulate can include particles below a threshold size. For example, in some embodiments, the wood particulate can include particles measuring less than or equal to about 5 mm, less than or equal to about 4 mm, less than or equal to about 3 mm, or less than or equal to about 2 mm in length. The percentage of particles below the threshold size can be about 100%, greater than about 95%, greater than about 90%, greater than about 85%, or greater than about 80% of the wood particulate by weight. In some embodiments, the wood particulate can be passed through a sieve having pores about 2 mm in diameter before being used to form composite board 200.

Composite board 200 can also include a polymer that is bonded to the wood particulate and bonds the wood particulate together. For example, composite board 200 can include a thermoplastic polymer (e.g., high-density polyethylene (HDPE)). In some embodiments, composite board 200 also includes a coupling agent (e.g., HDPE highly functionalized with maleic anhydride) to help bond the thermoplastic polymer to the wood particulate. In some embodiments, composite board 200 can also include a flame retardant (e.g., microencapsulated ammonium polyphosphate). The formation of composite board 200 will be discussed in more detail with respect to FIG. 4.

As shown in FIGS. 2A-2B, composite board 200 can have a length L, a width W less than the length L, and a height H less than or equal to the width W. As used herein, a “board” can refer to any wood or wood composite material having a regular shape and at least one dimension smaller than any other dimension (e.g., a height less than a length and a width, a width less than a length, a height and width that are equal, but less than a length, etc.).

In some embodiments, length L can be between about 20 inches and about 60 inches. For example, in some embodiments, length L can be between about 20 inches and about 50 inches, between about 20 inches and about 45 inches, between about 20 inches and about 40 inches, between about 25 inches and about 35 inches, or about 30 inches. Length L can depend on how many door hardware supports 106 are included within composite board 200 and the lengths (L₁, L₂, L₃, L₄. . . ) of door hardware supports 106. In some embodiments, composite board 200 can include between two door hardware supports 106 and 10 door hardware supports 106. For example, in some embodiments, composite board 200 can include between two door hardware supports 106 and eight door hardware supports 106, between two door hardware supports 106 and six door hardware supports 106, or between two door hardware supports 106 and four door hardware supports 106.

In some embodiments, width W can be between about 2 inches and about 6 inches. For example, in some embodiments, width W can be between about 2 inches and about 5.5 inches, between about 2 inches and about 5 inches, between about 2.5 inches and about 4.5 inches, between about 3 inches and about 4 inches, or about 3.25 inches. Width W can depend on the intended widths of door hardware supports 106 included in composite board 200.

In some embodiments, height H can be between about 1 inch and about 3 inches. For example, in some embodiments, height H can be between about 1 inch and about 2.5 inches, between about 1 inch and about 2 inches, between about 1 inch and about 1.5 inches, or about 1.1 inches.

The description of a length L, width W, and height H above should not be construed to mean that composite board 200 is a perfect rectangular prism. Indeed, in some embodiments, composite board 200 can have a varying width W along length L, a varying height H along length L or width W, or a varying length L along width W.

In some embodiments, composite board 200 can include one or more scoring recesses 202 spaced apart along length L. For example, in some embodiments, composite board 200 can include a first scoring recess 202a, a second scoring recess 202b, and a third scoring recess 202c. As shown in FIG. 2A, each scoring recess 202 can extend across width W. Additionally, as shown in FIG. 2B, each scoring recess 202 can define an area of decreased height h relative to an adjacent height H of composite board 200, an adjacent height being a height H of a portion of composite board 200 directly abutting a scoring recess 202. In some embodiments, decreased height h of composite board 200 at each scoring recess 202 can be configured such that each door hardware support 106 is manually breakable at the scoring recesses 202 from other door hardware supports 106 in composite board 200. For example, composite board 200 can be manually breakable at scoring recesses 202 to form a first door hardware support 106a, a second door hardware support 106b, a third door hardware support 106c, and a fourth door hardware support 106d. As used herein, “manually breakable” can mean not requiring additional machinery or tools to break the composite board 200. For example, a human can break off one door hardware support 106 from composite board 200 by hand.

In some embodiments, a scoring recess 202 can have a depth d greater than half of an adjacent height H of composite board 200. For example, in some embodiments, depth d be between about 0.5 times and about 0.95 times an adjacent height H, between about 0.5 times and about 0.9 times an adjacent height H, between about 0.5 times and about 0.85 times an adjacent height H, between about 0.5 times and about 0.8 times an adjacent height H, between about 0.5 times and about 0.75 times an adjacent height H, between about 0.5 times and about 0.7 times an adjacent height H, between about 0.5 times and about 0.65 times an adjacent height H, or between about 0.5 times and about 0.6 times an adjacent height H. The ratio of depth d to an adjacent height H can depend on the adjacent height H. For example, in a thicker composite board 200, a scoring recess 202 may have a greater depth d as compared to an adjacent height H to ensure composite board 200 is manually breakable at the scoring recess (i.e., to ensure the decreased height h is manually breakable).

In some embodiments, a decreased height h of composite board 200 at a scoring recess 202 can be between about 0.2 inches and about 0.8 inches. For example, in some embodiments, a decreased height h at a scoring recess 202 can be between about 0.3 inches and about 0.7 inches, between about 0.4 inches and about 0.6 inches, or about 0.5 inches. In some embodiments, a decreased height h at a scoring recess 202 can be selected to make composite board 200 manually breakable at the scoring recess 202. In some embodiments, a decreased height h at a scoring recess 202 can additionally be selected so that composite board 200 does not break too easily at the scoring recess 202. For example, a decreased height h at a scoring recess 202 can be selected so that composite board 200 does not break under its own weight at the scoring recess 202.

In some embodiments, a decreased height h at a scoring recess 202 can depend on one or more of the following factors: the density of composite board 200 at the scoring recess 202, the hardness of composite board 200 at the scoring recess 202, and the weight of composite board 200.

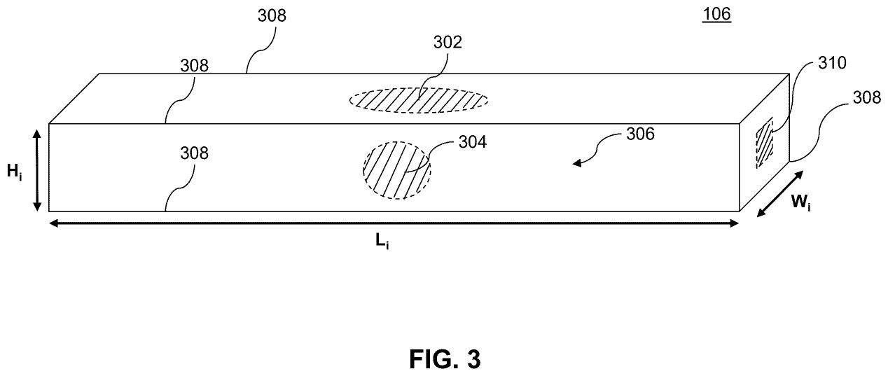

In some embodiments, composite board 200 can include a hollow cross-sectional profile, as described with respect to FIG. 3. In some embodiments, a decreased height h at a scoring recess 202 can match a bottom wall thickness of the hollow composite board 200.

A scoring recess 202 can have a width w. In some embodiments, width w can be between about 0.1 inches and about 0.3 inches. For example, in some embodiments, width w can be between about 0.1 inches and about 0.25 inches, between about 0.1 inches and about 0.2 inches, or about 0.15 inches.

While FIGS. 2A-2B show a composite board 200 including four door hardware supports 106a-d, a composite board 200 can include any number of door hardware supports 106, for example, one, two, three, five, six, seven, eight, nine, or 10 door hardware supports 106. In addition, while a composite board 200 having only a single row of door hardware supports 106 is shown, a composite board 200 including multiple rows of door hardware supports 106, each row separated by a longitudinal scoring recess running along length L, is contemplated. In such embodiments, a plurality of door hardware supports 106 may be formed by breaking composite board 200 along scoring recesses 202 and along the longitudinal scoring recess(es).

While FIGS. 2A-2B show scoring recesses 202 separated by lengths L₁, L₂, L₃, and L₄ of door hardware supports 106a-d, in some embodiments, scoring recesses 202 can be separated by widths of door hardware supports 106a-d such that L₁, L₂, L₃, and L₄ are oriented perpendicularly to length L of composite board 200.

FIG. 3 shows a door hardware support 106 according to some embodiments. In some embodiments, door hardware support 106 can be formed by breaking composite board 200 along a scoring recess 202. However, in some embodiments, door hardware support 106 can be formed by molding door hardware support 106 separately, either by extrusion or injection molding. In any case, door hardware support 106 can be a composite door hardware support. That is, it can be formed using a combination of wood particulate (e.g., sawdust) and a polymer, as described herein. In some embodiments, the wood particulate and the polymer can be as described with respect to FIGS. 2A-2B. Additionally, in some embodiments, door hardware support 106 can include a coupling agent or a flame retardant such as those described with respect to FIGS. 2A-2B.

As shown in FIG. 3, door hardware support 106 can have a length Lᵢ, a width Wᵢ less than the length Lᵢ, and a height Hᵢ less than or equal to the width Wᵢ. The subscript “i” in FIG. 3 indicates that door hardware support 106 can be one of a plurality of door hardware supports 106 included in composite board 200. “i” indicates an index value of a door hardware support 106 within composite board 200 as shown in FIG. 2A. In some embodiments, the plurality of door hardware supports 106 can have the same lengths Lᵢ, widths Wᵢ, and heights Hᵢ. In some embodiments, the plurality of door hardware supports can have one or more of different lengths Lᵢ, different widths Wᵢ, and different heights Hᵢ.

In some embodiments, length Lᵢ can be between about 5 inches and about 15 inches. For example, in some embodiments, length Lᵢ can be between about 9 inches and about 15 inches, between about 10 inches and about 14 inches, between about 11 inches and 13 inches, about 12 inches, between about 5 inches and about 12 inches, between about 5 inches and about 9 inches, between about 6 inches and about 9 inches, between about 6.5 inches and about 8.5 inches, between about 7 inches and about 8 inches, or about 7.5 inches.

In some embodiments, width Wᵢ can be between about 2 inches and about 6 inches. For example, in some embodiments, width Wᵢ can be between about 2 inches and about 5.5 inches, between about 2 inches and about 5 inches, between about 2.5 inches and about 4.5 inches, between about 2 inches and about 4 inches, between about 3 inches and about 4 inches, or about 3.25 inches.

In some embodiments, height Hᵢ can be between about 1 inch and about 3 inches. For example, in some embodiments, height Hᵢ can be between about 1 inch and about 2.5 inches, between about 1 inch and about 2 inches, between about 1 inch and about 1.5 inches, or about 1.1 inches.

The description of a length Lᵢ, width Wᵢ, and height Hᵢ above should not be construed to mean that door hardware support 106 is a perfect rectangular prism. Indeed, in some embodiments, door hardware support 106 can have a varying width Wᵢ along length Lᵢ, a varying height Hᵢ along length Lᵢ or width Wᵢ, or a varying length Lᵢ along width Wᵢ.

Door hardware support 106 can include a plurality of longitudinal edges 308. Longitudinal edges 308 can extend along the length Lᵢ of door hardware support 106. In some embodiments, the surface of door hardware support 106 can define a non-zero radius of curvature at one or all of longitudinal edges 308. That is, one or more of longitudinal edges 308 need not form perfect corners but can be eased edges. In some embodiments, the radius of curvature at a longitudinal edge 308 can be between about 0.05 inches and about 0.5 inches. For example, in some embodiments, the radius of curvature can be between about 0.1 inches and about 0.45 inches, between about 0.1 inches and about 0.4 inches, between about 0.1 inches and about 0.35 inches, between about 0.1 inches and about 0.3 inches, or between about 0.1 and about 0.2 inches. The radius of curvature at a longitudinal edge 308 can depend on height Hᵢ or width Wᵢ. For example, in some embodiments, the radius of curvature at a longitudinal edge 308 can be less than 0.2 times height Hᵢ.

In some embodiments, door hardware support 106 can include a first cavity 302 and a second cavity 304. First and second cavities 302, 304 can be configured to receive at least a portion of a handle assembly (e.g., handle assembly 108). For example, first cavity 302 can be configured to receive a chassis coupled to a doorknob or door lever (e.g., doorknob or door lever 110). Second cavity 304 can be configured to receive a bolt (e.g., latch assembly 112). In use, the bolt can extend through second cavity 304 and a portion of frame 102 of door 100 to catch on a cavity of a door jamb.

First and second cavities 302, 304 can be formed before or after door hardware support 106 is installed in a door (e.g., door 100). Accordingly, door hardware support 106 may be formed and sold without cavities 302, 304. Cavities 302, 304 are optional features in the manufacturing of door hardware support 106. Additionally, while FIG. 3 shows door hardware support 106 including both first and second cavities 302, 304, in some embodiments, door hardware support 106 only includes first cavity 302. In such embodiments, first cavity 302 can abut a face 306 of door hardware support 106 that abuts a frame of a door (e.g., frame 102 of door 100) in use. Accordingly, in such embodiments, latch assembly 112 may extend only through frame 102, rather than through a portion of door hardware support 106 and frame 102.

In some embodiments, door hardware support 106 can optionally include a hollow cross-sectional profile. For example, FIG. 3 shows an extrusion cavity 310 formed within door hardware support 106. Extrusion cavity 310 can extend along length Lᵢ for all or a portion of length Lᵢ. In some embodiments, extrusion cavity 310 can be formed using a mandrel during the extrusion process, as described with respect to FIG. 4. If door hardware support 106 forms part of composite board 200, in some embodiments, extrusion cavity 310 can form a portion of an extrusion cavity that extends along length L of composite board 200 for all or a portion of length L. In some embodiments, extrusion cavity 310 can be entirely hollow. In some embodiments, extrusion cavity 310 can include a honeycomb structure formed from the composite material of door hardware support 106/composite board 200. While an extrusion cavity 310 is illustrated, this feature is optional and door hardware support 106/composite board 200 can be solid.

FIG. 4 shows a method 400 of manufacturing one or more door hardware supports (e.g., door hardware supports 106) according to some embodiments. The one or more door hardware supports can be for one or more hollow core or semi-solid core doors.

In some embodiments, method 400 can include the following steps: (1) collecting wood particulate created as a waste product during a door manufacturing process; (2) forming a composite board (e.g., composite board 200) using the collected wood particulate; and (3) scoring the composite board. In some embodiments, the entity collecting the wood particulate in the wood-particulate collection step is also the entity conducting the door manufacturing process. In some embodiments, the wood-particulate collection includes step 404 as described below. In some embodiments, composite-board-forming step includes steps 406, 408, and 410 as described below. In some embodiments, scoring step includes step 412 as described below.

In some embodiments, step 2 includes injection molding. In some embodiments, step 2 includes any other suitable manufacturing method for forming a composite board including a polymer and wood particulate (e.g., compression molding or thermoforming).

Unless stated otherwise, the steps of method 400 need not be performed in the order set forth herein. Additionally, unless otherwise specified, the steps of method 400 need not be performed sequentially. The steps can be performed in a different order or simultaneously. As one example, step 402 need not be performed before step 404, but can be performed simultaneously with step 404. As another example, step 406 need not be performed after steps 402 and 404, but can be performed simultaneously with steps 402 or 404. Further, method 400 need not comprise all the steps illustrated. For example, method 400 need not include step 402 if the wood particulate of step 404 is obtained from a source other than manufacturing one or more doors. As another example, method 400 need not comprise step 406 if the wood particulate of step 404 is already sufficiently dry. As another example, method 400 need not include steps 412 and 414 if the wood composite extrusion of step 410 (or a composite product formed using another manufacturing method) is a single door hardware support or if the wood composite extrusion/product is cut into multiple door hardware supports without scoring the wood composite extrusion/product. As another example, method 400 need not include step 414 if the end product is a scored wood composite extrusion/product (e.g., composite board 200) produced at step 412, and a separate party performs step 414.

Step 402 can include manufacturing one or more doors. The one or more doors can be hollow core doors, semi-solid core doors, or solid core doors. Manufacturing the one or more doors can include cutting, sanding, milling, drilling, or routing components (e.g., stiles, rails, doorskins, panels, mullions, knob cavities, etc.) of the one or more doors.

Step 404 can include collecting wood particulate. In some embodiments, the wood particulate can be created as a waste product during a door manufacturing process (e.g., step 402). For example, the wood particulate can include wood dust, wood chips, or wood shavings produced by sawing/cutting, sanding, milling, drilling, or routing various door components (e.g., stiles, rails, doorskins, panels, mullions, knob cavities, etc.) of the one or more doors.

In some embodiments, the wood particulate can be or include wood particulate produced in routing one or more components of a door, for example, one or more panels, mullions, or core of a solid core door. In some embodiments, the routing can be performed using a CNC routing apparatus. Routing can produce wood particulate with an overall smaller particle size in comparison to other woodworking techniques (e.g., sawing). Additionally, routing can produce particles of substantially uniform size. In such embodiments, the need for sorting the wood particulate to remove particles over a threshold size, as discussed below, can be reduced or eliminated. In some embodiments, wood particulate produced in routing one or more components of a door can be greater than 50%, greater than 60%, greater than 70%, greater than 80%, or greater than 90% of the wood particulate by weight.

In some embodiments, the wood particulate can be or include wood particulate produced in sawing one or more components of a door.

In some embodiments, the wood particulate can be or include wood particulate produced in sanding one or more components of a door. The wood particulate being or including particles produced in sanding can secure the same benefits as for particles produced in routing. In some embodiments, wood particulate produced in sanding one or more components of a door can be greater than 50%, greater than 60%, greater than 70%, greater than 80%, or greater than 90% of the wood particulate by weight. In some embodiments, wood particulate produced in sanding and in routing one or more components of a door can together be greater than 50%, greater than 60%, greater than 70%, greater than 80%, or greater than 90% of the wood particulate by weight.

In some embodiments, door components being sawn/cut, sanded, milled, drilled, or routed can include solid wood, wood laminate, or a wood composite such as plywood, blockboard, chipboard, oriented strand board (OSB), medium or high density fiberboard (MDF, HDF), hardboard, or any other wood or wood composite.

In some embodiments, the wood particulate can include multiple types of wood (e.g., from the manufacturing of multiple doors or types of doors). In some embodiments, the wood particulate can include a single type of wood (e.g., from the manufacturing of a single door or type of door).

In some embodiments, collecting the wood particulate in step 404 can include sorting the wood particulate to remove particles of unwanted size or foreign matter. In some embodiments, sorting the wood particulate can include passing the wood particulate through a sieve or other mesh filter. In some embodiments, the pores of the sieve or mesh filter can have a maximum diameter (e.g., measured along the diagonal of a pore if the pores are square) less than or equal to about 7 mm, for example, less than or equal to about 5 mm, less than or equal to about 4 mm, less than or equal to about 3 mm, or less than or equal to about 2 mm. In some embodiments, sorting the wood particulate can include removing particles over a threshold size, for example, particles measuring greater than 2 mm, greater than 3 mm, greater than 4 mm, greater than 5 mm, or greater than 7 mm in length. In some embodiments, the percentage of particles of the wood particulate below the threshold size can be about 100%, greater than about 95%, greater than about 90%, greater than about 85%, or greater than about 80% of the wood particulate by weight. The weight percentage of particles below the threshold size can be determined by considering the collective weight of particles below the threshold size or the collective weight of particles above the threshold size in a random sample of 0.25 pounds (lbs) of the wood particulate. In some embodiments, collecting the wood particulate in step 404 can include grinding the wood particulate to produce particles less than the threshold size.

While collecting wood particulate is described, in some embodiments, step 404 can alternatively include obtaining wood particulate from another source. For example, wood particulate (e.g., wood flour, sawdust, wood shavings, wood chips, etc.) can be purchased from another party.

Step 406 can include drying the wood particulate. In some embodiments, drying the wood particulate can include air-drying the wood particulate. In some embodiments, drying the wood particulate can include heating the wood particulate. Drying the wood particulate can be performed using any suitable dryer, for example, a suspension dryer, direct rotary dryer, indirect rotary dryer, vacuum rotary dryer, rotary drum dryer, pipe dryer, etc. In some embodiments, drying can be performed until a moisture content of the wood particulate is below about 15%, for example, below about 12%, below about 10%, below about 8%, or below about 6% by weight. The wood particulate used to form the moldable wood composite in step 408 can have a moisture content below any of the above thresholds at the time of combination with a polymer. The moisture content of the wood particulate by weight can be determined using a loss on drying (LOD) test, which can include the following steps: obtaining a random 0.25 lb sample of the wood particulate, drying the sample (e.g., heating the sample in an oven) until its weight ceases to decrease, subtracting the final dry weight of the sample from the initial weight of the sample (0.25 lbs), dividing the result by the initial weight, and converting the fractional result to a percentage. In some embodiments, step 406 can include drying the wood particulate until the moisture content of the wood particulate is substantially uniform. In some embodiments, drying the wood particulate can be performed before combining it with a thermoplastic polymer. Accordingly, drying the wood particulate can be performed before forming a moldable wood composite in step 408.

Step 408 can include forming a moldable wood composite using the wood particulate. In some embodiments, forming the moldable wood composite can include combining wood particulate with one or more of a polymer, a coupling agent, and a flame retardant. In some embodiments, the polymer can be a thermoplastic polymer. As example materials, the polymer can be high-density polyethylene (HDPE), the coupling agent can be HDPE highly functionalized with maleic anhydride, and the flame retardant can be microencapsulated ammonium polyphosphate. However, other polymers, coupling agents, or flame retardants can be implemented. An example formulation for the moldable wood composite is includes, for example, between about 45% and 55% wood particulate by weight, between about 35% and 45% thermoplastic polymer by weight, between about 0% and about 12% flame retardant by weight, and between about 0% and about 8% coupling agent by weight.

Alternative formulations for a moldable wood composite are contemplated. For example, in some embodiments, a formulation need not include a coupling agent, a flame retardant, or both. In some embodiments, a thermoplastic polymer that can serve as its own coupling agent can be used.

In some embodiments, forming the moldable wood composite can include pelletizing the formulation using a pelletizing system. An example pelletizing system is an underwater pelletizing system. Pellets including wood particulate and thermoplastic polymer, flame retardant, coupling agent, or any combination thereof, can then be fed into an extrusion machine. An example extrusion machine is a screw extruder, for example, configured for production of wood plastic composites (WPC) or natural fiber composites (NFC). The pellets can be heated (e.g., by the extrusion machine) to at least partially melt the thermoplastic polymer, thereby forming the moldable wood composite. In some embodiments, the moldable wood composite can be heated pellets that have been formed into a semi-solid or liquid composite within the extrusion machine.

Step 410 can include passing the moldable wood composite through a die to form a wood composite extrusion (e.g., unscored composite board 200 or door hardware support 106). In some embodiments, the die can include a rectangular cross-section. For example, the die can have an interior surface against which the moldable wood composite is pressed when it is passed through the die. This interior surface can define a rectangle such that a rectangular shape can be imparted to the moldable wood composite. Accordingly, in some embodiments, the wood composite extrusion can include a rectangular cross-section. For example, once cooled, the wood composite extrusion can be a composite board (e.g., unscored composite board 200) or a door hardware support (e.g., door hardware support 106) having a length, a width less than the length, and a height less than or equal to the width. Regardless, the wood composite extrusion can comprise one or more door hardware supports. In the case of the wood composite extrusion comprising a plurality of door hardware supports, the door hardware supports can be obtained from the wood composite extrusion by scoring or cutting the wood composite extrusion as discussed herein.

“Rectangular” as used herein should not be construed to mean perfectly rectangular. In contrast, the interior surface of the die can define a non-zero radius of curvature at its corners. A die can include a “rectangular” cross-section when the radii of curvature defined by its interior surface at its corners are less than 0.2 times a height of the cavity through which the moldable wood composite passes (corresponding to the height of an extruded composite board or door hardware support).

In some embodiments, the die can include a mandrel including a projection extending into the center of the die cavity. The moldable wood composite can flow around the projection such that the wood composite extrusion includes a hollow cross-sectional profile, as shown in FIG. 3 (element 310). In some embodiments, the projection can be rectangular and can be positioned to cause walls of a resulting hollow wood composite extrusion to have substantially uniform thickness. In some embodiments, the mandrel can include a plurality of projections in an array and extending along the flow path within the die cavity in use. The moldable wood composite can flow around and between the projections such that the wood composite extrusion includes a hollow cross-sectional profile including a honeycomb structure. The projections can have rectangular, hexagonal, or circular cross sections, or cross sections of any other shape. Wood composite extrusions including hollow cross-sectional profiles can cool more quickly than solid wood composite extrusions.

While extrusion is discussed above, in some embodiments, step 410 can alternatively include using injection molding, compression molding, or thermoforming to form a wood composite board or a door hardware support, which can include the properties of the wood composite extrusion and can be similarly processed in steps 412 and 414 as discussed herein.

Step 412 can include scoring the wood composite extrusion at one or more breakage lines, thereby defining a plurality of door hardware supports (e.g., door hardware supports 106). The one or more breakage lines can correspond to scoring recesses 202 of composite board 200. In some embodiments, scoring the wood composite extrusion at the one or more

breakage lines can include passing the wood composite extrusion through a saw assembly. In some embodiments, the saw assembly can include a flying saw and a conveyor. The conveyer can move the wood composite extrusion in a direction parallel to its lengthwise axis (e.g., parallel to length L of composite board 200). The flying saw can be coupled to a carriage and can move in three dimensions to follow the wood composite extrusion as it moves, contact the wood composite extrusion, and score the wood composite extrusion by movement perpendicular to the lengthwise axis of the wood composite extrusion. The movement of the conveyer and the flying saw can be programmed using an integrated or external computer in communication with the saw assembly. A user can program the saw assembly to determine the lengths Lᵢ of individual door hardware supports 106 and the depths d of individual scoring recesses 202. In some embodiments, the flying saw and conveyor can be configured to partially cut the wood composite extrusion at regular intervals corresponding to the lengths Lᵢ of multiple substantially uniform door hardware supports 106. In some embodiments, the flying saw and conveyor can be configured to partially cut the wood composite extrusion at irregular intervals corresponding to the lengths Lᵢ of multiple door hardware supports 106 of different lengths.

In some embodiments, the saw assembly can include a plurality of spaced apart blades configured to partially cut the wood composite extrusion. The blades can be spaced apart according to the lengths Lᵢ of resulting door hardware supports 106 and positioned parallel to one another. For example, for the configuration of the wood composite extrusion shown in FIG. 2A, the blades can include three blades spaced apart by L₂ and L₃. A first blade can be spaced apart from a second blade by L₂, and the second blade can be spaced apart from a third blade by L₃. In some embodiments, the blades can be spaced from a surface by a height corresponding to height h shown in FIG. 2B. The wood composite extrusion can be positioned parallel to an axis of rotation of the blades and placed in contact with the blades to score the wood composite extrusion at the one or more breakage lines simultaneously. For example, in some embodiments, the lengthwise axis of the wood composite extrusion can be positioned parallel to the axis of rotation of the blades. The wood composite extrusion can then be pushed over the surface beneath the blades, while contacting the blades, in a direction perpendicular to the axis of rotation.

In some embodiments, the moldable wood composite can be formed into a wood composite extrusion that defines a single composite board (e.g., composite board 200). In some embodiments, a wood composite extrusion can be configured to be cut into multiple composite boards. For example, the wood composite extrusion can be cut after extrusion to form multiple composite boards 200. In some embodiments, the cutting of the wood composite extrusion can be accomplished using a plurality of spaced apart blades. The blades can be spaced apart according to the widths W or heights H of resulting composite boards 200 and positioned parallel to one another. The wood composite extrusion can be passed through the blades to cut the wood composite extrusion into multiple composite boards 200 simultaneously.

The scoring of the wood composite extrusion can occur before or after cutting the

wood composite extrusion into multiple composite boards 200.

In some embodiments, the wood composite extrusion need not be scored, but can be cut into a plurality of door hardware supports directly without a scoring 412 or breaking step 414, for example, using the flying saw described above.

Step 414 can include breaking the wood composite extrusion at the one or more breakage lines to form the plurality of door hardware supports (e.g., door hardware supports 106). In some embodiments, the wood composite extrusion can be broken manually, as described with respect to FIGS. 2A-2B.

Once the one or more door hardware supports of method 400 have been manufactured, they can be installed in one or more doors as described with respect to FIGS. 1A-1B. Multiple door hardware supports can be installed in a single door in a multi-point locking system, or a single door hardware support can be installed in a door.

Manufacturing composite extruded or molded door hardware supports from a waste product of a door manufacturing process can save costs for materials and reduce further material waste. Additionally, a composite material of wood particulate and a polymer can exhibit the structural integrity (e.g., hardness, tensile strength, etc.) necessary for door hardware support applications, in which a door hardware support secures a handle assembly or lock assembly to a door and resists attempts to compromise the handle or lock assembly. In some embodiments, composite door hardware supports as disclosed herein can exhibit greater flame resistance and tensile strength as compared to door hardware supports made from other wood composites (e.g., oriented strand board (OSB)).

Composite door hardware supports including a hollow cross-sectional profile (e.g., including an entirely hollow or honeycomb structure extrusion cavity) can reduce the amount of materials required to manufacture the door hardware supports, thereby lowering production costs related to obtaining or collecting wood particulate, polymer, or other materials. A honeycomb structure extrusion cavity can increase structural integrity while still reducing material cost.

Lastly, a composite board including a one or more scoring recesses can provide an efficient means of manufacturing, storing, or shipping multiple door hardware supports simultaneously. The multiple door hardware supports can be formed by a user manually breaking the composite board at the scoring recesses, without additional machinery being required. Forming the composite board using an extrusion process can increase efficiency of manufacturing by properly defining the dimensions of multiple door hardware supports using a single extrusion and scoring process.

The foregoing description of the specific embodiments described with reference to the figures will so fully reveal the general nature of the disclosure that others can, by applying knowledge within the skill of the art, readily modify or adapt for various applications such specific embodiments, without undue experimentation, without departing from the general concept of this disclosure.

While various embodiments of this disclosure have been described above, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of this disclosure. The elements of the embodiments presented above are not necessarily mutually exclusive, but can be interchanged to meet various needs as would be appreciated by one of skill in the art.

It is to be understood that the phraseology or terminology used herein is for the purpose of description and not of limitation. The breadth and scope of this disclosure should not be limited by any of the above-described exemplary embodiments but should be defined only in accordance with the following claims and their equivalents.

It is to be appreciated that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

What is claimed is:

1. A method of manufacturing one or more door hardware supports for one or more hollow core or semi-solid core doors, the method comprising:
collecting wood particulate created as a waste product during a door manufacturing process;
forming a moldable wood composite using the collected wood particulate; and
passing the moldable wood composite through a die comprising a rectangular cross-section to form a wood composite extrusion comprising one or more door hardware supports.

2. The method of claim 1, wherein collecting the wood particulate comprises sorting the wood particulate to remove particles above a threshold size.

3. The method of claim 1, further comprising drying the wood particulate before forming the moldable wood composite.

4. The method of claim 1, the wood particulate comprising wood particulate produced in routing a component of a door.

5. The method of claim 4, wherein the door is a solid core door.

6. The method of claim 1, the wood particulate comprising wood particulate produced in sawing a component of a door.

7. The method of claim 1, the wood particulate comprising wood particulate produced in sanding a component of a door.

8. The method of claim 1, further comprising scoring the wood composite extrusion at one or more breakage lines, thereby defining a plurality of door hardware supports.

9. The method of claim 8, further comprising breaking the wood composite extrusion at the one or more breakage lines to form the plurality of door hardware supports.

10. The method of claim 8, wherein scoring the wood composite extrusion at the one or more breakage lines comprises passing the wood composite extrusion through a saw assembly, the saw assembly comprising a flying saw and a conveyer configured to partially cut the wood composite extrusion at regular intervals.

11. A composite board comprising:
wood particulate comprising a waste product of manufacturing one or more doors;
a thermoplastic polymer;
a length, a width less than the length, and a height less than or equal to the width; and
a plurality of scoring recesses spaced apart along the length, each scoring recess extending across the width and defining an area of decreased height relative to an adjacent height of the composite board, the composite board configured to be manually breakable at the scoring recesses to form a plurality of door hardware supports.

12. The composite board of claim 11, wherein the length is between 20 inches and 50 inches.

13. The composite board of claim 11, wherein the width is between 2 inches and 6 inches.

14. The composite board of claim 11, wherein the height is between 1 inch and 3 inches.

15. The composite board of claim 11, wherein the plurality of door hardware supports comprises between 2 door hardware supports and 8 door hardware supports.

16. The composite board of claim 15, wherein the plurality of door hardware supports comprises between 2 door hardware supports and 4 door hardware supports.

17. A door hardware support for a door, comprising:
wood particulate comprising a waste product of manufacturing one or more doors;
a thermoplastic polymer; and
a length, a width less than the length, and a height less than or equal to the width, the length being between 5 inches and 15 inches, the width being between 2 inches and 6 inches, and the height being between 1 inch and 3 inches.

18. The door hardware support of claim 17, further comprising a cavity configured to receive at least a portion of a handle assembly.

19. The door hardware support of claim 17, wherein the length is between 5 inches and 9 inches, the width is between 2 and 4 inches, and the height is between 1 and 2 inches.

20. The door hardware support of claim 17, comprising a hollow cross-sectional profile.
